(19) United States
(12) Patent Application Publication
(10) Pub. No.: US 2026/0352827 A1
(43) Pub. Date: Nov. 5, 2026

(54) Wavefront Scan Order for Transform Coefficient Coding

(71) Applicant: Google LLC, Mountain View, CA (US)

(72) Inventors: Cheng Chen, Milpitas, CA (US); Yaowu Xu, Saratoga, CA (US); Xiang Li, Saratoga, CA (US); Jingning Han, Santa Clara, CA (US); Bohan Li, Santa Clara, CA (US)

(21) Appl. No.: 19/125,551

(22) PCT Filed: Dec. 15, 2022
(86) PCT No.: PCT/US2022/053026

§ 371 Date: Apr. 29, 2025

Related U.S. Application Data
(60) Provisional application No. 63/421,855, filed on Nov. 2, 2022.

(51) Int. Cl. H04N 19/129; H04N 19/176; H04N 19/18; H04N 19/70

(52) U.S. Cl. CPC H04N 19/129; H04N 19/176; H04N 19/18; H04N 19/70

(57) ABSTRACT

Coding a quantized transform block includes coding a position of an end-of-block coefficient in the quantized transform block. Quantized transformed coefficients of the quantized transform block are coded using a wavefront scan order. The wavefront scan order is characterized by coding respective quantized transform coefficients of flipped L-shaped regions. First quantized transform coefficients along a first axis of a flipped L-shaped region are coded followed by coding second quantized transform coefficients along a second axis of the flipped L-shaped region.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

Encoding based on motion estimation and compensation may be performed by breaking frames or images into blocks that are predicted based on one or more prediction blocks of reference frames. Differences (i.e., residual errors) between blocks and prediction blocks are compressed and encoded in a bitstream. A decoder uses the differences and the reference frames to reconstruct the frames or images.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing device, cause the device to perform the actions. One general aspect includes a method for coding a quantized transform block. The method also includes coding a position of an end-of-block coefficient in the quantized transform block. The method also includes coding quantized transformed coefficients of the quantized transform block using a wavefront scan order, where the wavefront scan order is characterized by coding respective quantized transform coefficients of flipped L-shaped regions, and where first quantized transform coefficients along a first axis of a flipped L-shaped region are coded followed by coding second quantized transform coefficients along a second axis of the flipped L-shaped region. Other embodiments of this aspect include corresponding computer systems, apparatus, and computer programs recorded on one or more computer storage devices, each configured to perform the actions of the methods.

Implementations may include one or more of the following features. The method may include determining cartesian coordinates of an end-of-block coefficient in the quantized transform block. Coding the position of the end-of-block coefficient in the quantized transform block may include coding a first syntax element indicating a wavefront that includes the end-of-block coefficient. Coding the position of the end-of-block coefficient in the quantized transform block further may include coding a second syntax element indicating whether the end-of-block coefficient is in a column or a row of the wavefront. The method may include coding a third syntax element indicating an offset of the end-of-block coefficient within the one of the column or the row of the wavefront. Coding the position of the end-of-block coefficient in the quantized transform block further may include coding a second syntax element indicating an offset of the end-of-block coefficient to a predetermined location in the wavefront. The wavefront scan order may be selected in response to determining that a two-dimensional transform is used to obtain the quantized transform block from a pixel-domain residual block. The flipped L-shaped region includes a quantized transform coefficient at a location (p, p) of the quantized transform block and all other quantized transform coefficient have coordinates (p, y) and (x, p) such that y≤p and x≤p.

One general aspect includes a device for coding a quantized transform block. The device also includes a processor, the processor is configured to code a position of an end-of-block coefficient in the quantized transform block; and code quantized transformed coefficients of the quantized transform block using a wavefront scan order, where the wavefront scan order is characterized by coding respective quantized transform coefficients of flipped L-shaped regions, and where first quantized transform coefficients along a first axis of a flipped L-shaped region are coded followed by coding second quantized transform coefficients along a second axis of the flipped L-shaped region. Other embodiments of this aspect include corresponding computer systems, apparatus, and computer programs recorded on one or more computer storage devices, each configured to perform the actions of the methods.

Implementations may include one or more of the following features. The device where the processor is further configured to determine cartesian coordinates of an end-of-block coefficient in the quantized transform block. To code the position of the end-of-block coefficient in the quantized transform block may include to code a first syntax element indicating a wavefront that includes the end-of-block coefficient. To code the position of the end-of-block coefficient in the quantized transform block further may include to code a second syntax element indicating whether the end-of-block coefficient is in a column or a row of the wavefront. The processor can be further configured to code a third syntax element indicating an offset of the end-of-block coefficient within the one of the column or the row of the wavefront. To code the position of the end-of-block coefficient in the quantized transform block further may include to code a second syntax element indicating an offset of the end-of-block coefficient to a predetermined location in the wavefront. The wavefront scan order can be selected in response to determining that a two-dimensional transform is used to obtain the quantized transform block from a pixel-domain residual block. The flipped L-shaped region includes a quantized transform coefficient at a location (p, p) of the quantized transform block and all other quantized transform coefficient have coordinates (p, y) and (x, p) such that y≤p and x≤p. Implementations of the described techniques may include hardware, a method or process, or computer software on a computer-accessible medium.

One general aspect includes a non-transitory computer-readable storage medium. The non-transitory computer-readable storage medium also includes coding a position of an end-of-block coefficient in the quantized transform block. The medium also includes coding quantized transformed coefficients of the quantized transform block using a wavefront scan order, where the wavefront scan order is characterized by coding respective quantized transform coefficients of flipped L-shaped regions, and where first quantized transform coefficients along a first axis of a flipped L-shaped region are coded followed by coding second quantized transform coefficients along a second axis of the flipped L-shaped region. Other embodiments of this aspect include corresponding computer systems, apparatus, and computer programs recorded on one or more computer storage devices, each configured to perform the actions of the methods.

Implementations may include one or more of the following features. The non-transitory computer-readable storage medium where the operations further may include determining cartesian coordinates of an end-of-block coefficient in the quantized transform block. Coding the position of the end-of-block coefficient in the quantized transform block may include coding a first syntax element indicating a wavefront that includes the end-of-block coefficient. Coding the position of the end-of-block coefficient in the quantized transform block further may include coding a second syntax element indicating whether the end-of-block coefficient is in a column or a row of the wavefront. The operations may further include coding a third syntax element indicating an offset of the end-of-block coefficient within the one of the column or the row of the wavefront. Coding the position of the end-of-block coefficient in the quantized transform block may further include coding a second syntax element indicating an offset of the end-of-block coefficient to a predetermined location in the wavefront. The wavefront scan order is selected in response to determining that a two-dimensional transform is used to obtain the quantized transform block from a pixel-domain residual block. The flipped L-shaped region includes a quantized transform coefficient at a location (p, p) of the quantized transform block and all other quantized transform coefficient have coordinates (p, y) and (x, p) such that y≤p and x≤p. Implementations of the described techniques may include hardware, a method or process, or computer software on a computer-accessible medium.

These and other aspects of the present disclosure are disclosed in the following detailed description of the embodiments, the appended claims and the accompanying figures. It will be appreciated that aspects can be implemented in any convenient form. For example, aspects may be implemented by appropriate computer programs which may be carried on appropriate carrier media which may be tangible carrier media (e.g., disks) or intangible carrier media (e.g., communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of a technique for coding a quantized transform block using a wavefront scan order.

FIG. 7 illustrates examples of coding a position of an end-of-block.

FIG. 8 illustrates examples of coding quantized transform coefficients using a wavefront scan order.

FIG. 9 illustrates an example of a backward (i.e., reverse) zigzag scan order and context selection.

FIG. 10 illustrates an example of trellis optimization for determining quantization levels of transform coefficients of a transform block.

FIG. 11 is a flowchart diagram of a technique for coding a quantized transform block using a wavefront scan order.

### DETAILED DESCRIPTION

As mentioned above, compression schemes related to coding video streams may include breaking images into blocks and generating a digital video output bitstream using one or more techniques to limit the information included in the output. A received encoded bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between the previously coded pixel values and those in the current block. In this way, only the residual and parameters used to generate the residual need be added to the encoded bitstream. The residual may be encoded using a lossy quantization step.

As further described below, the residual block can be in the pixel domain. The residual block can be transformed into the frequency domain resulting in a transform block of transform coefficients. The transform coefficients can be quantized resulting into a quantized transform block of quantized transform coefficients. The quantized coefficients can be entropy encoded and added to an encoded bitstream. A decoder can receive the encoded bitstream, entropy decode the quantized transform coefficients to reconstruct the original block.

Entropy coding is a technique for lossless coding that relies upon probability models that model the distribution of values occurring in an encoded video bitstream. By using probability models based on a measured or estimated distribution of values, entropy coding can reduce the number of bits required to represent video data close to a theoretical minimum. In practice, the actual reduction in the number of bits required to represent video data can be a function of the accuracy of the probability model, the number of bits over which the coding is performed, and the computational accuracy of fixed-point arithmetic used to perform the coding.

A probability model, as used herein, can be, or can be a parameter in, a lossless (entropy) coding. An arithmetic coder (AC) can be used to losslessly encode a symbol (also referred to as a syntax element) corresponding to a transform coefficient. A model can be any parameter or method that affects probability estimation for the purpose of entropy coding. In an example, a two-pass process to learn the probabilities for a current frame may be used. In another example, a model may define a certain context derivation method.

In an encoded video bitstream, many of the bits are used for one of two things: either content prediction (e.g., inter mode/motion vector coding, intra prediction mode coding, etc.) or residual coding (e.g., transform coefficients). Encoders may use techniques to decrease the number of bits spent on coefficient coding.

In some codecs, to encode a quantized transform block, a scan order is selected for traversing the block according to the scan order. When a quantized transform coefficient is visited, a probability distribution is selected for coding the quantized transform coefficient. A context (selected according to a context model) is determined for selecting the probability distribution. An indicator of the end-of-block coefficient (EOB) may also be coded. The EOB is the last non-zero quantized transform coefficient in the scan order. Quantized transform coefficients that follow the EOB in the scan order need not be coded because, by the definition of the EOB, such coefficients are known to be zero.

The algorithm (including how the EOB is encoded, how the quantized transform block is traversed, and the accuracy of selected probability models) used for encoding transform coefficients has a substantial impact on the compression efficiency, throughput, and memory consumption for software and hardware implementations of codecs.

Implementations according to this disclosure use a wavefront scan order to code (e.g., encode or decode) quantized transform coefficients. The wavefront scan order can reduce the bitrate and result in higher compression efficiency. Techniques disclosed herein for coding a quantized transform block using a wavefront scan order includes techniques for signalling of EOBs, techniques for scanning (e.g., traversing) the quantized transform coefficients of a block, and techniques for context model designs.

The wavefront scan order is characterized dividing a quantized transform block into flipped L-shaped regions. The transform coefficients along a first axis (e.g., vertical) of a flipped L-shaped region are coded first followed by the transform coefficients along a second axis (e.g., horizontal) of the flipped L-shaped region. Coding of transform coefficients along each of the axes proceeds in reverse order starting at the transform coefficient corresponding to the intersection of the two axes. The transform coefficient corresponding to the intersection of the two axes can be a transform coefficient along a diagonal line of the quantized transform block.

As signal correlation may be present in the transform coefficients, neighboring information (i.e., the context) can be helpful to code each transform coefficient. AC can achieve a higher compression ratio when a good estimation of the symbol probability is available. An AC can use the context to better estimate the probability of the quantized transform coefficients. As such, a good design of transform coefficient coding that takes contexts into consideration is also described herein.

Additionally, and as further described below, in the process of obtaining a quantized transform block from a transform block, an encoder may use an optimization technique (such as trellis optimization) to jointly determine quantization levels for the transform coefficients. Trellis optimization may perform best when first-order dependencies (explained below) exist between the transform coefficients for context modelling. As further described below, conventional scan orders do not result in first-order dependencies. The wavefront scan order described herein can solve problems such as these because it results in first order dependencies for at least some (if not most) of the transform coefficients of a transform block.

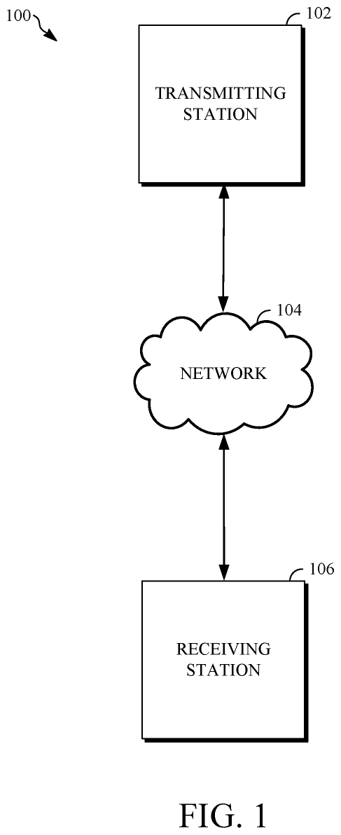

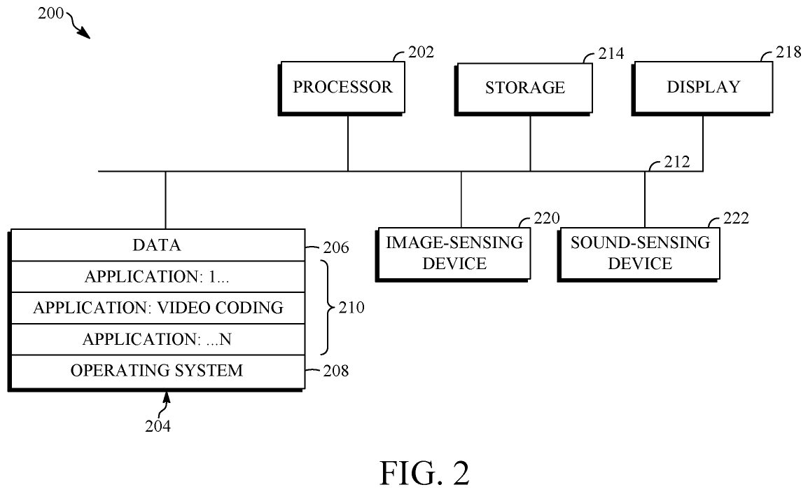

Further details of techniques for coding a transform block using a wavefront scan order are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown (e.g., the CPU 202), advantages in speed and efficiency can be achieved by using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described herein. For example, the application programs 210 can include applications 1 through N, which further include a video coding application that performs the techniques described here, such as the techniques for coding transform blocks using wavefront scan order. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

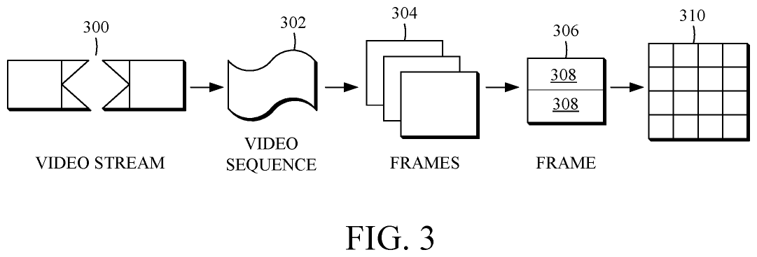

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

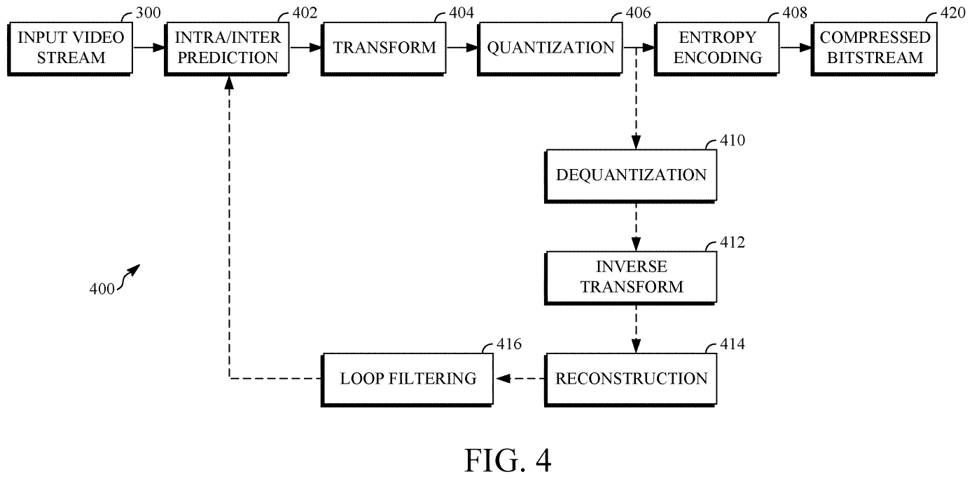

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

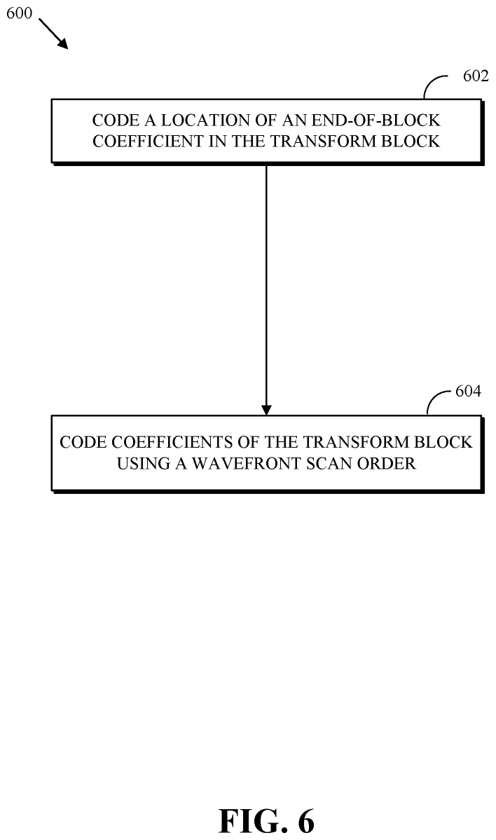

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. Implementations for forming a prediction block are discussed below with respect to FIGS. 6, 7, and 8, for example, using parameterized motion model identified for encoding a current block of a video frame.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block (which may include, for example, the type of prediction used, transform type, motion vectors and quantizer value), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

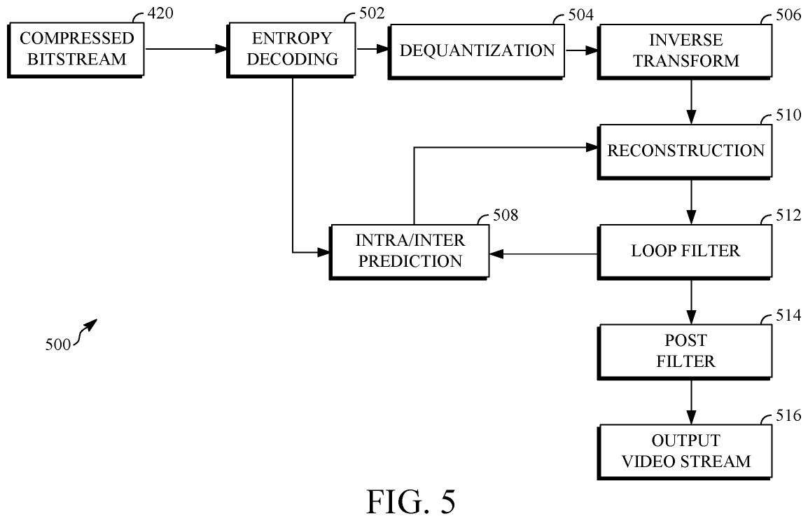

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 is applied to the reconstructed block to reduce blocking distortion or perform other post-processing on a frame, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

FIG. 6 is a flowchart diagram of a technique 600 for coding a quantized transform block using a wavefront scan order. The technique 600 can include coding a position of an end-of-block coefficient in the quantized transform block; and coding quantized transformed coefficients of the quantized transform block using a wavefront scan order.

The technique 600 can be implemented in a decoder, such as the decoder 500 of FIG. 5, or an encoder, such as the encoder 400 of FIG. 4. When implemented by a decoder, “to code” (and related terms) mean “to decode,” such as from a compressed bitstream (e.g., the compressed bitstream 420 of FIG. 5). When implemented by an encoder, “to code” (and related terms) mean “to encode,” such as in a compressed bitstream (e.g., the compressed bitstream 420 of FIG. 4).

The technique 600 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 600. In at least some implementations, the technique 600 can be performed in whole or in part by the entropy encoding stage 408 of FIG. 4 of the encoder 400 of FIG. 4 or the entropy decoding stage 502 of the decoder 500 of FIG. 5. As such, the technique 600 can be used by a decoder to decode a quantized transform block from a compressed bitstream that is to be input (e.g., processed, dequantized, etc.) by the dequantization stage 504. The technique 600 can be used by an encoder to encode a quantized transform block received from the quantization stage 406 into the compressed bitstream.

The technique 600 can be implemented using specialized hardware or firmware. Some computing devices can have multiple memories, multiple processors, or both. The steps or operations of the technique 600 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

In an example, the technique 600 can be used to code the quantized transform block regardless of the transform type (e.g., one-dimensional vertical, one-dimensional, two-dimensional transform types) used to obtain the transform block from a residual block (or vice versa). In an example, the technique 600 can be used to code the quantized transform block when the transform used to obtain the transform block is a two-dimensional transform type; otherwise, a different scan order is used. As such, the wavefront scan order can be selected in response to determining that a two-dimensional transform is used to obtain the quantized transform block from a pixel-domain residual block.

At 602, a position of an EOB coefficient in the transform block is coded. The position of the EOB coefficient can be defined such that the coordinates of any non-zero quantized transform coefficient of the quantized transform block must be smaller or equal to the coordinates of EOB. As such, if (x₀, y₀) represents the horizontal and vertical coordinates of the EOB (if a Cartesian coordinate is used), and (xᵢ, yᵢ) represents the coordinates of any quantized transform coefficient in the block, and if xᵢ>x₀ or yᵢ>y₀, then this quantized transform coefficient must be zero. Said another way, a flipped L-shaped region includes a quantized transform coefficient at a location (p, p) of the quantized transform block and all other quantized transform coefficient having coordinates (p, y) and (x, p) such that y≤p and x≤p.

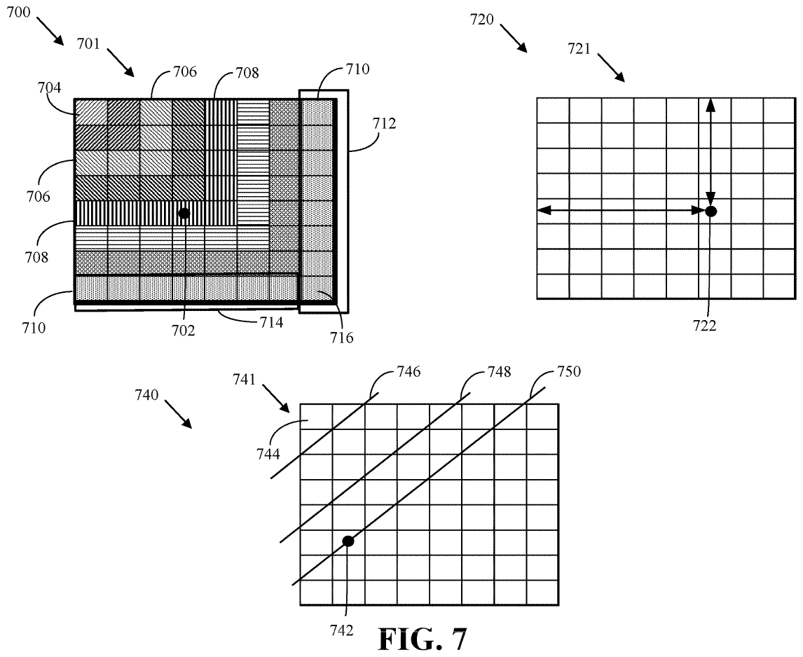

The position of the EOB can be coded using any number of different techniques. A few examples are described with respect to FIG. 7. However, other ways of using at least two syntax elements to code the position of the EOB are possible and the disclosure is not limited to the examples described with respect to FIG. 7.

FIG. 7 illustrates examples 700, 720, and 740 of coding a position of an EOB. FIG. 7 illustrates quantized transform blocks 701, 721, and 741 as being of size 8×8. However, the disclosure is not so limited, and the transform block can be of any size.

In the example 700, an EOB 702 illustrates the position of the last non-zero coefficient of the quantized transform block 701. The position of the last non-zero coefficient is defined as described above. The quantized transform block 701 is divided (at least logically) into wavefronts with a top-left pixel 704 as the origin. In an example, if the quantized transform block is of size N×N, then the quantized transform block can include N wavefronts, such as wavefronts 706, 708, and 710. Coding the EOB as described with respect to the example 700 is referred to herein as the wavefront design for EOB coding.

As mentioned, a wavefront is a flipped L-shaped set of coefficients that includes a first set of coefficients along a first axis and a second set of coefficients along a second axis such that the first and second axes meet at a transform coefficient that is on the diagonal of the transform block. To illustrate, the wavefront 710 includes a first set of coefficients 712 along the vertical axis and a second set of coefficients 714 along a horizontal axis. The axes meet at a coefficient 716, which is on the diagonal of the quantized transform block. The diagonal element (i.e., the coefficient 716) is included in one but not both of the first set of coefficients or the second set of coefficients. As illustrated in FIG. 7, the diagonal element is included in the vertical set of coefficients.

In an example, the position of the EOB coefficient can be coded using two syntax elements. A first syntax element (e.g., symbol) can indicate a wavefront that includes the end-of-block coefficient. That is, the first syntax element can represent which wavefront the EOB is in. To illustrate, the first syntax element can be or represent the value 4 indicating that the EOB 702 is in the 5th wavefront of the quantized transform block.

A second syntax element can indicate an offset of the EOB to a predetermined location in the wavefront. For example, the second syntax element can indicate the offset of the EOB to a top-most location of the wavefront. As such, the second syntax element can indicate a value of 5 (indicating that the EOB is the 6th quantized transform coefficient in the wavefront). The predetermined location in the wavefront can be the diagonal coefficient (e.g., the coefficient 716). Other predetermined locations in the wavefront are possible.

In another example, the position of the EOB coefficient can be coded using three syntax elements. The first syntax element can indicate a wavefront that includes the EOB, as described above. A second syntax element can indicate which of the first or the second sets of coefficients of the wavefront includes the EOB. To illustrate, a value of 0 may indicate that the EOB is in the first set of coefficients and a value of 1 indicates that the EOB is in the second set of coefficients. A third syntax element can indicate an offset of the EOB within the subset the one of the first or the second set of coefficients. As such, in an example, a second syntax element is coded to indicate whether the end-of-block coefficient is in a column or a row of the wavefront; and a third syntax element is coded to indicate an offset of the end-of-block coefficient within the one of the column or the row of the wavefront. The offset can be measured from a predetermined location, such as the diagonal location (e.g., the coefficient 716).

In the example 720, Cartesian coordinates of an EOB 722 of the quantized transform block 721 can be used to encode a position of the EOB 722. As such, a first syntax element can be used to code the horizontal offset of the EOB and a second syntax element can be used to code a vertical offset of the EOB in a Cartesian coordinate system that has an origin at the direct current (DC) coefficient. That is, the origin can be the top-left corner of the quantized transform block 721, which is the block location (0, 0) of the quantized transform block). As such, with respect to the EOB 722, the first syntax element and the second syntax element can be used to code the values 5 and 4, respectively. Coding the EOB as described with respect to the example 720 is referred to herein as the diagonal design for EOB coding.

The example 740 illustrates using a coordinate system having an origin at the DC coefficient (i.e., a coefficient 744) and characterized by anti-diagonal lines (such as anti-diagonal lines 746, 748, 750) to code a position of an end-of-block coefficient (EOB) 742 of a quantized transform block 741. Each coefficient of the quantized transform block 741 may be located at a Cartesian location (col, row). For example, the EOB 742 is at Cartesian location (1, 5). The anti-diagonal lines of the example 740 can be lines such that quantized transform coefficients of the quantized transform block 741 having the same value col+row are on the same anti-diagonal line. For example, the anti-diagonal line 746 includes those coefficients having col+row=1. As such, the quantized transform coefficients at locations (0, 1) and (1, 0) are on the anti-diagonal line 746. As another example, the anti-diagonal line 748 includes those quantized transform coefficients having col+row=4. As such, the anti-diagonal line 746 includes the quantized transform coefficients at Cartesian locations (4, 0), (3, 1), (2, 2), (1, 3), and (0, 4).

Coding a position of the EOB can include coding a first syntax element indicating the anti-diagonal line (i.e., an index therefor) that includes the EOB. In an example, a second syntax element can indicate an offset on the line from a predetermined location (e.g., the bottom-left location) of the anti-diagonal line. As such, with respect to the EOB 742, the first syntax element and the second syntax element can indicate, respectively, the values 6 and 1. In another example, the second syntax element can be used to code a distance of the EOB to a centre of the anti-diagonal line, and a third syntax element can be used to indicate whether the EOB is in the bottom-left or the upper-right region of the diagonal line.

The syntax elements used to code the location of the EOB can be entropy coded using cumulative distribution functions (CDFs) that represent different probability models conditioned on different factors. The factors can include one or more of the size of the quantized transform block, the color channel that the quantized transform block corresponds to, and the transform type used to obtain the transform block from which the quantized transform block is obtained. The color channel may be, for example, the luminance (Y) channel or one of the chrominance (U or V) channels. The transform type may be, for example, a two-dimensional transform, a 1-dimensional vertical transform, or a one-dimensional horizontal transform. Other transform types are possible. In an example, each transform block can be associated with a fixed combination of these factors. To illustrate, for a quantized transform block of size 8×8, Y channel, 2D transform, both the encoder and the decoder can use a corresponding CDF to write/read (i.e., encode/decode) the symbols that indicate the value of EOB.

To further refine the probability model selection, additional factors that are based on the technique used for coding the position of the EOB can be used.

For example, in the wavefront design for EOB coding, and as mentioned, a first syntax element can represent which flipped L-shaped region the EOB is in; a second syntax element can be a Boolean indicating whether the EOB is on the horizontal or the vertical axis; and a third syntax element can represent the offset to the diagonal coefficient. In an example, the third syntax element can have separate probability models for each of the horizontal and vertical axes. That is, if the second syntax element has a first value, then one probability model can be selected for coding the third syntax element; and if the second syntax element has a second value, then another probability model can be selected for coding the third syntax element. As such, the context model of the third syntax element includes the second syntax element.

For example, in the diagonal design for EOB coding, and as described above, a first symbol can indicate which anti-diagonal line the EOB is in. Different ways can be used to indicate the offset of EOB on the line. In an example, the offset can be defined as a distance to the bottom-left corner of the current line. In another example, a second syntax element can code the distance of the EOB to the center of the anti-diagonal line and a third syntax element can be used to indicate whether the EOB is in the bottom-left or the upper-right region. As such, different probability models can be associated with these different design alternatives.

At 604 of FIG. 6, the quantized transformed coefficients of the quantized transform block are coded using a wavefront scan order. The wavefront scan order is characterized by coding respective quantized transform coefficients of flipped L-shaped regions. That is, each flipped L-shaped regions includes a subset of the quantized transformed coefficients of the quantized transform block; and the quantized transform coefficients are coded one flipped L-shaped region at a time. Transform coefficients along a first axis of a flipped L-shaped region are coded first followed by coding second quantized transform coefficients along a second axis of the flipped L-shaped region. The quantized transform coefficients along a first axis of a flipped L-shaped region are coded first followed by coding of second quantized transform coefficients along a second axis of the flipped L-shaped region.

Each quantized transform coefficient is entropy coded (encoded into and decoded from a compressed bitstream). Different techniques can be used to code quantized transform coefficients. In an example, the levels (e.g., values) of the quantized transform coefficients can be broken into different planes. A lower-level plane may correspond to coefficient levels between 0 and 2, whereas a higher-level plane can be used to code levels that are above 2. The separation into planes can be used to assign a rich context model to at least the lower-level plane. In an example, the context can include one or more of the size of the quantized transform block and neighboring coefficient information. The higher-level plane can use a reduced context model for levels between 3 to 15 and may directly code the residuals above level 15 using an ExpGolomb code.

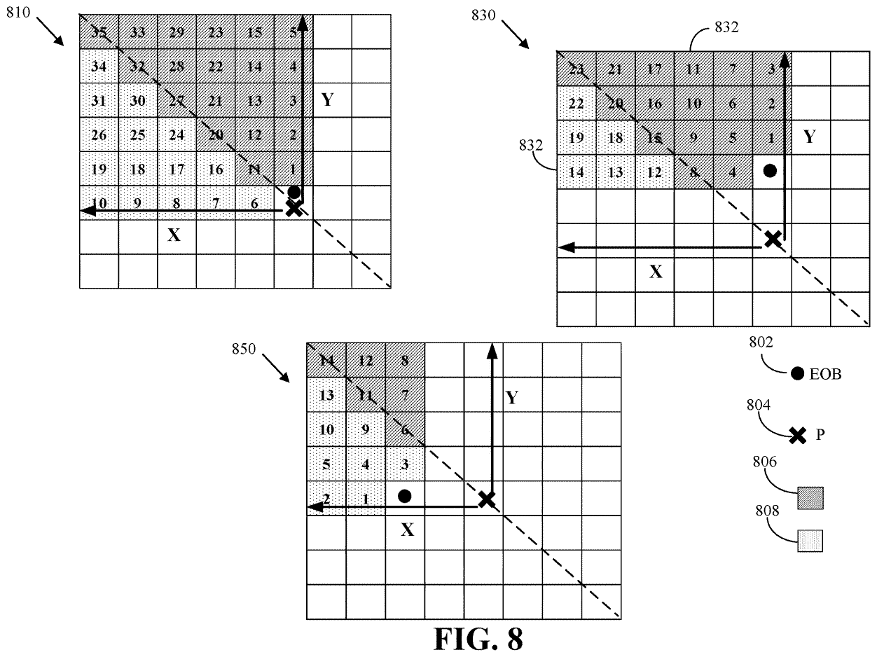

Coding the quantized transform block using the wavefront scan order is now explained with reference to FIG. 8. FIG. 8 illustrates examples of coding quantized transform coefficients using a wavefront scan order. FIG. 8 includes quantized transform blocks 810, 830, and 850. Each of the quantized transform block 810, 830, 850 is shown as including a symbol 802 that indicates the location of the EOB in that block and as including a symbol 804 that indicates the location of a diagonal location (described further below). As such, in the quantized transform block 810, the EOB is at the coordinates (5, 5) and the diagonal location is also at (5, 5); in the quantized transform block 830, the EOB is at the coordinates (5, 3) and the diagonal location is at (5, 5); and in the quantized transform block 850, the EOB is at the coordinates (2, 5) and the diagonal location is at (5, 5). Coding the quantized transform block using the wavefront scan order can be summarized as follows.

Let (x, y) represent the offset of a quantized transform coefficient with the top-left corner as origin. The coordinate of the EOB is given by (x₀, y₀).

First, a diagonal location P is located. The coordinates of the diagonal location are given by (x₁, y₁) and satisfy the conditions: x₁=y₁, x₁>x₀, y₁>y₀. And for any other pixel (x₂, y₂), which also satisfies x₂=y₂, x₂>=x₀, y₂>=y₀, it is requires that the diagonal location P is the closest to the EOB: x₁<x₂. As such, the diagonal location is a diagonal location of the quantized transform block that is on the same horizontal axis or the same vertical axis as the EOB, whichever has the larger value. That is, if x₀>y₀, then the diagonal location P is at (x₀, x₀); and if x₀<y₀, then the diagonal location P is at (y₀, y₀).

The diagonal location P can be used to identify a flipped L-shaped region. Starting from the diagonal location P, transform coefficients are sequentially coded along a first direction (e.g., the vertical direction) until a block boundary (e.g., the top boundary of the quantized transform block) is reached, followed by a second direction (e.g., the horizontal direction) until a block boundary (e.g., the left boundary of the quantized transform block) is reached. Quantized transform coefficients whose coordinates (xᵢ, yᵢ) satisfy xᵢ>x₀ or yᵢ>y₀ are skipped (i.e., not coded). These coefficients are known to be zero.

After coding all the quantized transform coefficients of the current flipped L-shaped region, coding advances to the next smaller flipped L-shaped region until no more flipped L-shaped region are available. If a current flipped L-shaped region is defined by a diagonal location (p, p), then the next smaller flipped L-shaped region is defined by a diagonal location (p-1, p-1).

The numbers shown at the locations of the quantized transform coefficients in each of the quantized transform blocks 810, 830, 850 illustrate the coding order of the coefficients of that block. X and Y indicate the directions or coding order. Shaded squares indicate that the coefficients are coded along the vertical (shaded with a pattern 806) and horizontal (shaded with a pattern 808) direction.

Table I illustrates a pseudocode for coding a quantized transform block using a wavefront scan order. Other ways of implementing coding a quantized transform block using a wavefront scan order are possible and the disclosure herein is not limited by the illustrated pseudocode of Table I. Table I illustrates a case where two syntax elements (eob_symbol_1 and eob_symbol_2) are used to code the EOB. However, as mentioned above, more than two syntax elements can be used. The function ƒ(·) at row 3 takes symbols and determines the coordinates of EOB. The actual implementation of the function ƒ(·) depends on the way that symbols for coding the EOB are defined, as described with respect to FIG. 7.

| | |
|---|---|
| 1 | eob_symbol_1 |
| 2 | eob_symbol_2 |
| 3 | EOB = f(eob_symbol_1, eob_symbol_1) |
| 4 | theMax = max(EOBx, EOBy) |
| 5 | P = theMax |
| 6 | for (wav=theMax; wav >= 0; wav−−) { |
| 7 | //go up |
| 8 | if EOBx >= wav |
| 9 | for up = P; up >= 0; up−− |
| 10 | if yEOB > up |
| 11 | code coeff(wav, up) |
| 12 | //go across |
| 13 | if EOBy >= wav |
| 14 | for (across = P-1; across >= 0; across−−) |
| 15 | if EOBx >= across |
| 16 | code coeff(across, wav) |
| 17 | P−− |
| 18 | } |

In an example, all of the quantized transform coefficients in a block can share the same cumulative distribution function (CDF) (e.g., the same probability model). In another example, separate CDFs can be used for each of the axes of scanning. For example, two separate CDFs, one for the vertically scanned coefficients and another for the horizontally scanned coefficients can be used.

As mentioned above, coding a quantized transform block includes traversing the quantized transform block using a scan order and determining a context that can be used to select a probability distribution (e.g., estimate, model) for coding a particular quantized transform block. The context model can include already coded, neighboring quantized transform coefficients.

Traditionally, to encode a quantized transform block, quantized transform coefficients may first be serialized (from a 2D block) by the certain scan order. The scan order may be chosen so that, in the serialized 1-D vector, the quantized transform coefficients will yield some correlations with their neighboring quantized transform coefficients, or that the quantized transform coefficients would have certain characteristics by the order of the scan.

The quantized transform coefficients are then entropy coded according to (e.g., in the order given by) the scan order. The scan order may scan the quantized transform block in a reversed manner (i.e., from higher frequencies to lower frequencies ending at the DC coefficient). A proper probability distribution is assumed (e.g., used or selected) for each quantized transform coefficient for an entropy coder. The probability distributions may be also adaptively updated as more quantized transform coefficients are coded to adapt to the statistics of different video sequences.

To have a more accurate estimation of the probability distributions, context models are used to first categorize the current coefficient into different distributions. For example, when the neighboring coefficients are large, it is very possible that the current coefficient would possibly also have a larger variance.

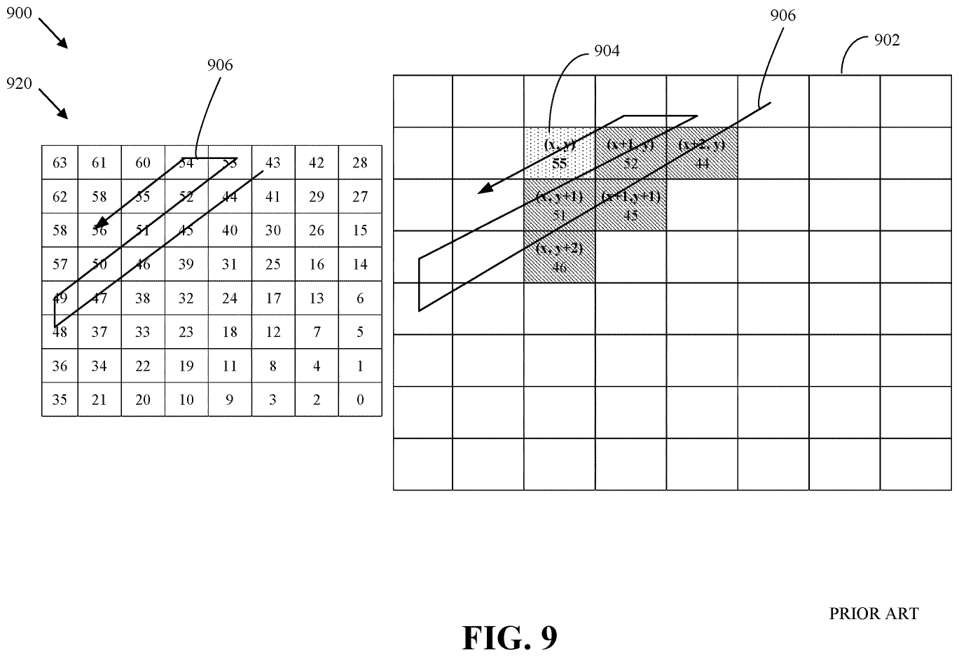

FIG. 9 illustrates an example 900 of a backward (i.e., reverse) zigzag scan order and context selection. A quantized transform block 902 is to be coded using a backward zigzag scan order 920. While the quantized transform block 902 is shown as being of size 8×8, the disclosure is not so limited. The quantized transform block 902 can have other N×N sizes. The numbers in the backward zigzag scan order 920 illustrate the order of visiting (e.g., traversing) the quantized transform block 902. While the backward zigzag scan order 920 illustrates that coding starts at the coefficient located at (N-1, N-1), that may not be the case. The starting point for traversing the quantized transform block 902 depends on the location of the EOB.

The quantized transform block 902 includes a current coefficient 904 that is located at Cartesian coordinates (x, y) and corresponds to scan order location 55. A line 906 illustrates the order of traversal (e.g. coding) of coefficients in the area of the current coefficient 904. The already coded, neighboring quantized transform coefficients (also referred to as the context coefficients) used for context selection include the coefficients at Cartesian locations (x+2, y), (x+1, y+1), (x, y+2), (x, y+1), and (x+1, y) corresponding, respectively, the scan order locations 44, 45, 46, 51, and 52. As such, To identify (e.g., select, choose, etc.) the proper probability distribution of the coding the current coefficient 904, the values of the indicated neighboring coefficients are used to provide an index of the proper probability distribution that the encoder and decoder use. In an example, the sum of context coefficients is used to obtain an index into the proper probability distribution.

As such, with context modeling, the coding of a current quantized transform coefficient becomes dependent on the value of its previously coded neighbors. In other words, the quantized value of the current coefficient will also influence the compression of future coefficients in this transform block. A “future coefficient” refers to a quantized transform coefficient that follows the current quantized transform coefficient in the scan order.

To better account for such dependency, an encoder may implement (e.g., apply) one or more optimization schemes to jointly decide the respective quantized values (e.g., the quantization levels) of the coefficients. One such, and known, optimization scheme is trellis optimization can be applied to a transform block to determine optimal quantization levels of the transform coefficients of the transform block. Trellis optimization is now briefly described.

Different states may be maintained for (e.g., associated with) each transform coefficient, where each state indicates a quantization level. For example, a first state (e.g. state 0) associated with a transform coefficient may indicate that regular quantization is to be applied to the transform coefficient; and a second state (e.g., state 1) may indicate that a reduced quantization level (e.g., subtract one from the quantization step size) is to be applied to the transform coefficient. Other states and/or other state semantics may be used. After associating states with the coefficients, at each coefficient, Trellis optimization considers the states from the previously coded coefficient and selects, for a current coefficient, the best origin state for each of the states maintained for the current coefficient. Trellis optimization may proceed from the EOB backwards to the start of the scan order. When the optimization is complete, the best path through all of the coefficients can be traced back from the start (e.g., the DC coefficient or the first scan order position) to the EOB (e.g., the last scan order position) to find the optimal path. The transform coefficients are then quantized according to the states of the optimal path.

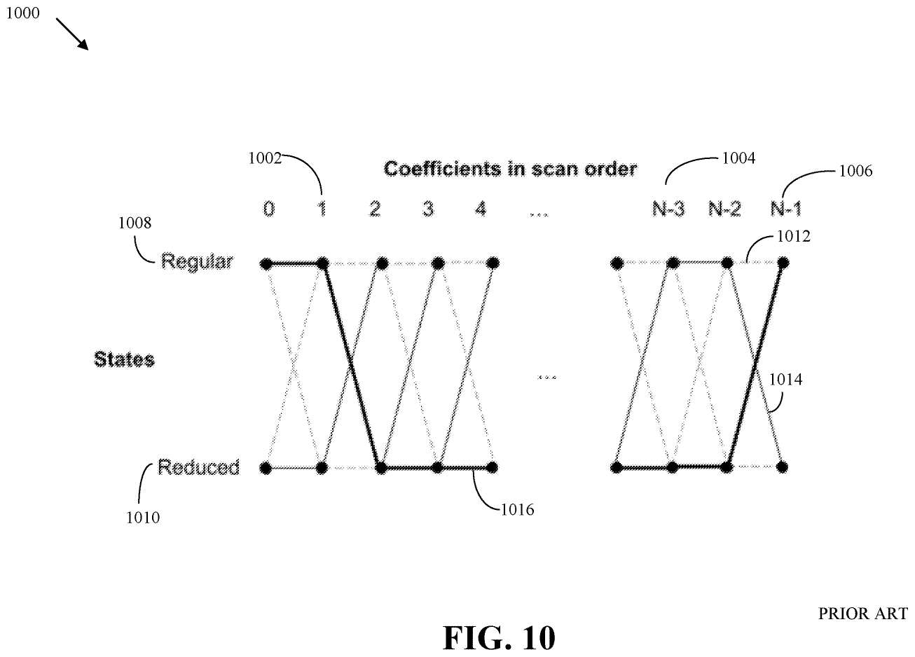

FIG. 10 illustrates an example 1000 of trellis optimization for determining quantization levels of transform coefficients of a transform block. The example 1000 illustrates transform coefficients at scan positions of a scan order, such as coefficients 1002, 1004, 1006 that are at respective scan positions 1, N-3, and N-1, where N corresponds to the number of scan positions. The example 1000 illustrates that two states are used: a regular quantization state 1008 and a reduced quantization state 1010.

For every transform coefficient, and for each of the possible states, trellis optimization may quantize a transform coefficient using the two origins (states) from the immediately preceding transform coefficient. To illustrate, with respect to the coefficient 1006, the coefficients 1006 is quantized based on a quantization of the coefficient 1004 using the regular quantization state 1008 (as illustrated by a line 1012) and as also based on a quantization of the coefficient 1004 using the reduced quantization state 1010 (as illustrated by a line 1014). Trellis optimization may then retain the optimal state (as illustrated by solid lines, such as the line 1014). Trellis optimization may then discard the other (e.g., non-optimal) states (e.g., the stated corresponding to the dotted lines, such as the line 1012). The better state can be the one that results in the better compression rate. Which is the better state can be determined based on a rate-distortion cost analysis. In the end, the best path (illustrated by a bold line 1016) can be retained as it corresponds to optimized quantization results of the transform coefficients.

Trellis optimization obtains better results when there are first-order dependencies between the transform coefficients. First-order dependencies means that the coding (e.g., quantizing) of a current transform coefficient only depends on the immediately preceding coded coefficients in the coding order (which may be the reversed scan order). When dependencies are not first order, trellis optimization may not result in a best optimization. Nevertheless, trellis optimization may still be effective when the dependencies are “local.” Local dependencies means that the context coefficients are not immediately preceding in the scan order but are in the Cartesian neighbourhood of the current coefficient. However, given scan orders and context models, such as those described with respect to FIG. 9, the context model neighbours, although quite local in the 2-D sense, are in fact far away from the current coefficient in the scan order therewith rendering trellis optimization ineffective or at least less optimal than in situations of first-order dependencies.

The foregoing suggests that to jointly optimize the quantized coefficients, the design of the context model and the scan order should both consider the optimization method used (such as the Trellis optimization). As mentioned above, the wavefront scan order described herein can solve problems such as these because it results in first order dependencies for at least some (if not most) of the transform coefficients of a transform block.

To obtain better optimization results, it is desirable for the scan order used to put at least part of the context dependencies into a local area in the scan. The wavefront scan order accomplishes such a result by, as described above, performing scans in a first direction (e.g., the vertical direction) followed by a scan in a second direction (e.g., the horizontal direction) in backward L-shaped regions. As such, the wavefront scan order can be said to consider the context model by placing at least part of the context dependencies into the local area in the scan.

To restate, traversing a quantized transform block using the wavefront scan order includes coding the quantized transform coefficients in each backward L-shaped region, starting from an outer-most (e.g., largest) backward L-shaped region toward inner (e.g., smaller) backward L-shaped regions. The outer-most backward L-shaped region is identified based on a location of the EOB, as described above with respect to FIG. 8. For each backward L-shaped region, the diagonal intersection quantized transform coefficient is coded, the quantized transform coefficients along a first direction (e.g., on the vertical line) are then code, and finally the quantized transform coefficients along a second direction (e.g., on the horizontal line) are coded.

Considering the context model of FIG. 9 (i.e., where the context for the coefficient at (x, y) includes the coefficients at locations (x+2, y), (x+1, y+1), (x, y+2), (x, y+1), and (x+1, y)), and the wavefront scan order described herein, at least some of these context coefficients are immediate neighbors in the scan order. To illustrate, consider scan location number 22 of the quantized transform block 810 of FIG. 8, its context coefficients include the quantized transform coefficients that are at scan locations 21, 20, 14, 13, and 4. As such, using the wavefront scan order, the coefficients at scan location 21 and 20 are the immediate neighbors in the scan of the quantized transform coefficient that is at scan location 22, which, in turns renders trellis optimization more effective.

As such, even if the same context model as that descried with respect to FIG. 9 is used, the context model for many of the quantized transform coefficients would include immediate neighbors in the scan order, which provides benefit in trellis coding over other scan orders. This is so even though, for some quantized transform coefficients (e.g., the quantized transform coefficients that are at the diagonal intersection points), none of the context coefficients are immediate neighbors.

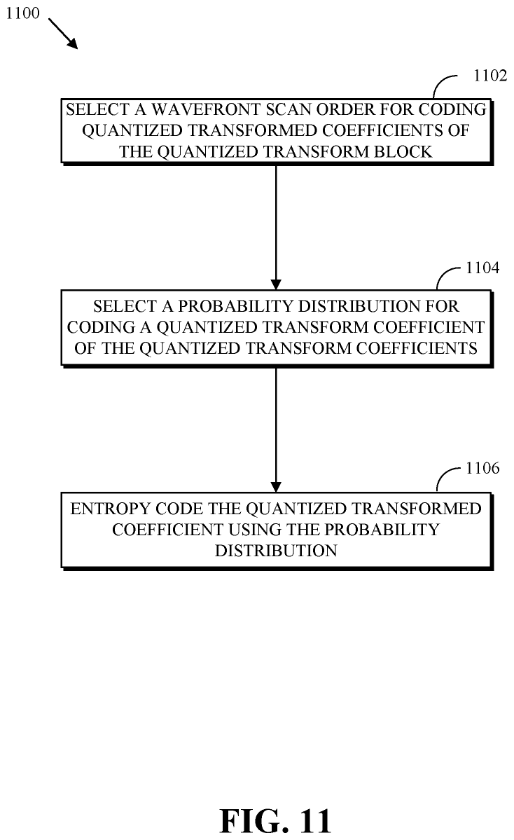

FIG. 11 is a flowchart diagram of a technique 1100 for coding a quantized transform block using a wavefront scan order. The technique 1100 can include selecting a wavefront scan order for coding quantized transformed coefficients of the quantized transform block; selecting a probability distribution for coding a quantized transform coefficient of the quantized transform coefficients; and entropy coding the quantized transformed coefficient using the probability distribution.

The technique 1100 can be implemented in a decoder, such as the decoder 500 of FIG. 5, or an encoder, such as the encoder 400 of FIG. 4. When implemented by a decoder, “to code” (and related terms) mean “to decode,” such as from a compressed bitstream (e.g., the compressed bitstream 420 of FIG. 5). When implemented by an encoder, “to code” (and related terms) mean “to encode,” such as in a compressed bitstream (e.g., the compressed bitstream 420 of FIG. 4).

The technique 1100 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 1100. In at least some implementations, the technique 1100 can be performed in whole or in part by the entropy encoding stage 408 of FIG. 4 of the encoder 400 of FIG. 4 or the entropy decoding stage 502 of the decoder 500 of FIG. 5. As such, the technique 1100 can be used by a decoder to decode a quantized transform block from a compressed bitstream that is to be input (e.g., processed, dequantized, etc.) by the dequantization stage 504. The technique 1100 can be used by an encoder to encode a quantized transform block received from the quantization stage 406 into the compressed bitstream.

The technique 1100 can be implemented using specialized hardware or firmware. Some computing devices can have multiple memories, multiple processors, or both. The steps or operations of the technique 1100 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

At 1102, a wavefront scan order is selected for coding quantized transformed coefficients of the quantized transform block. The quantized transform block can be of size N×N, where N is a positive integer. As described above, the wavefront scan order is such that locations (x+1,y), (x+1, y−1), and (x+1, x−2) are sequentially coded and locations (x, y+1), (x−1, y+1), and (x−2, y+1) are sequentially coded, for at least one x and one y where 2≤a≤N-1 and 2≤b≤N-1. As mentioned above, the wavefront scan order is characterized by coding respective quantized transform coefficients of flipped L-shaped regions and first quantized transform coefficients along a first axis of a flipped L-shaped region are coded followed by coding second quantized transform coefficients along a second axis of the flipped L-shaped region. As also described above, the flipped L-shaped region includes a quantized transform coefficient at a location (p, p) of the quantized transform block and all other quantized transform coefficient having coordinates (p, y) and (x, p) such that y≤p and x≤p.

At 1104, a probability distribution is selected for coding a quantized transform coefficient of the quantized transform coefficients. As described above, a context model for selecting the probability model includes at least two immediate neighbors of the quantized transform coefficient in the wavefront scan order. At 1106, the quantized transformed coefficient is coded using the probability distribution.

In some examples, the context can be selected in such a way as to better support a quantization optimization algorithm, such as trellis optimization. For example, since the immediate neighbors in the scan order are the ones that trellis coding can benefit more from, when generating (calculating) the context, instead of using a sum of the 2D neighbors, as described above, a weighted sum may be used instead. The weights for immediate neighbors can be larger than context coefficients that are not immediate neighbors in the wavefront scan order. As such, the technique 1100 can include obtaining a context as a weighted combination of context coefficients of the quantized transform coefficient. The context coefficients can include a first context coefficient that is an immediate neighbor of the quantized transform coefficient in wavefront scan order and a second context coefficient that is not an immediate neighbor. A first weight used with the first context coefficient can be larger than a second weight used with the second context coefficient.

A flipped L-shaped region can be thought of as being divided into sub-regions by the wavefront scan order; each sub-region includes the quantized transform coefficients coded in a particular direction, as described above. To illustrate, in the quantized transform block 830 of FIG. 8, a first sub-region of a flipped L-shaped region 832 includes the coefficients at scan locations 8, 9, 10, and 11; and a second sub-region of the flipped L-shaped region 832 includes the coefficients at scan locations 12, 13, and 14. Thus, as used herein those two coefficients are said to be “coded together” if they are in a same sub-region of a flipped L-shaped region.

In an example, the weight used for a context coefficient can depend on the location of the context coefficient in the quantized transform block and whether the context coefficient was coded together with the current coefficient. When coding a quantized transform coefficient along the vertical axis of a flipped L-shaped region, context coefficients that are in the same column of the flipped L-shaped region as, and coded together with, the quantized transform coefficient can be assigned higher weights than other context coefficients that are not in the same column.

To illustrate, and with reference again to FIG. 8, when coding the quantized transform coefficient at scan location 22 of the quantized transform block 810, larger weights can be used with the context coefficients at scan positions 21 and 20 than those used with the context coefficients at scan positions 14, 13, and 4. Similarly, when coding a quantized transform coefficient along the horizontal axis of the flipped L-shaped region, context coefficients that are in the same row as, and coded together with, the quantized transform coefficient can be assigned higher weights than other context coefficients that are not in the same row. As such, a first weight is used with a first context coefficient that is along a same dimension in the flipped L-shaped region as and coded together with the quantized transform coefficient and a second weight that is lower than the first weight is used with a second context coefficient that is not in the flipped L-shaped region.

In an example, the same weight (e.g., 1) can be used for context coefficients of quantized transform coefficients that are on a diagonal of the transform block (i.e., the diagonal elements of the flipped L-shaped regions). As such, when the quantized transform coefficient is located on a diagonal of the quantized transform block, the context can be a sum of context coefficients of the quantized transform coefficient.

In an example, the locations of context neighbors can be changed to (e.g., set, adapted to, selected based on, etc.) the scan order locality of the current quantized transform coefficient being coded. That is, which relative Cartesian neighbors used as context coefficients for a quantized transform coefficient depend on the location of the quantized transform coefficient in sub-region of the flipped L-shaped region the quantized transform coefficient belongs to. In an example, a number of immediate neighbors of the quantized transform coefficient used as context coefficients can depend on a location of the quantized transform coefficient. Said another way, a first set of context coefficients for a first quantized transform coefficient can include different relative neighbors than a second set of context coefficients for a second quantized transform coefficient.

To illustrate, for the coefficient located at scan position 13 of the quantized transform block 810 of FIG. 8, the context coefficients may include the coefficients at scan locations 12, 11, 3 and 2; and for the coefficient located at scan position 14, the context coefficients can be those coefficients at scan locations 13, 12, 11, 4, and 3. That is, more immediate neighbors may be used as contexts coefficients, when available. A context coefficient is available for a current coefficient if the context coefficient is coded together with the context coefficient. As described above, two quantized transform coefficients are coded together if they belong to the same sub-region of a flipped L-shaped region. As such, a context coefficient is available at least if the context coefficient is along the same axis (e.g., col or row) as the current quantized transform coefficient and is also in the same flipped L-shaped region. Similar adjustments can be made the quantized transform coefficients along the horizontal axis.

For simplicity of explanation, the techniques 600 and 1100 are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor (that is, the computer-readable medium can be a non-transitory computer-readable storage medium). The medium can be, for example, an electronic, magnetic, optical, electromagnetic, or semiconductor device. Other suitable mediums are also available.

The above-described embodiments, implementations, and aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. A method for coding a quantized transform block, comprising:
coding a position of an end-of-block coefficient in the quantized transform block; and
coding quantized transformed coefficients of the quantized transform block using a wavefront scan order,
wherein the wavefront scan order is characterized by coding respective quantized transform coefficients of flipped L-shaped regions, and
wherein first quantized transform coefficients along a first axis of a flipped L-shaped region are coded followed by coding second quantized transform coefficients along a second axis of the flipped L-shaped region.

2. The method of claim 1, further comprising:
determining Cartesian coordinates of an end-of-block coefficient in the quantized transform block.

3. The method of claim 1, wherein the wavefront scan order is selected in response to determining that a two-dimensional transform is used to obtain the quantized transform block from a pixel-domain residual block.

4. The method of claim 1, wherein the flipped L-shaped region includes a quantized transform coefficient at a location (p, p) of the quantized transform block and all other quantized transform coefficient have coordinates (p, y) and (x, p) such that y≤p and x≤p.

5. The method of claim 1, wherein coding the position of the end-of-block coefficient in the quantized transform block comprises:
coding a first syntax element indicating a wavefront that includes the end-of-block coefficient.

6. The method of claim 5, wherein coding the position of the end-of-block coefficient in the quantized transform block further comprises:
coding a second syntax element indicating whether the end-of-block coefficient is in a column or a row of the wavefront.

7. The method of claim 6, further comprising:
coding a third syntax element indicating an offset of the end-of-block coefficient within the one of the column or the row of the wavefront.

8. The method of claim 5, wherein coding the position of the end-of-block coefficient in the quantized transform block further comprises:
coding a second syntax element indicating an offset of the end-of-block coefficient to a predetermined location in the wavefront.

9. A device for coding a quantized transform block, comprising:
a processor, the processor configured to:
code a position of an end-of-block coefficient in the quantized transform block; and
code quantized transformed coefficients of the quantized transform block using a wavefront scan order,
wherein the wavefront scan order is characterized by coding respective quantized transform coefficients of flipped L-shaped regions, and
wherein first quantized transform coefficients along a first axis of a flipped L-shaped region are coded followed by coding second quantized transform coefficients along a second axis of the flipped L-shaped region.

10. The device of claim 9, wherein the processor is further configured to:
determine Cartesian coordinates of an end-of-block coefficient in the quantized transform block.

11. The device of claim 9, wherein the wavefront scan order is selected in response to determining that a two-dimensional transform is used to obtain the quantized transform block from a pixel-domain residual block.

12. The device of claim 9, wherein the flipped L-shaped region includes a quantized transform coefficient at a location (p, p) of the quantized transform block and all other quantized transform coefficient have coordinates (p, y) and (x, p) such that y≤p and x≤p.

13. The device of claim 9, wherein to code the position of the end-of-block coefficient in the quantized transform block comprises to:
code a first syntax element indicating a wavefront that includes the end-of-block coefficient.

14. The device of claim 13, wherein to code the position of the end-of-block coefficient in the quantized transform block further comprises to:
code a second syntax element indicating whether the end-of-block coefficient is in a column or a row of the wavefront.

15. The device of claim 14, wherein the processor is further configured to:
code a third syntax element indicating an offset of the end-of-block coefficient within the one of the column or the row of the wavefront.

16. The device of claim 13, wherein to code the position of the end-of-block coefficient in the quantized transform block further comprises to:
code a second syntax element indicating an offset of the end-of-block coefficient to a predetermined location in the wavefront.

17. A non-transitory computer-readable storage medium storing a compressed bitstream, the compressed bitstream comprising a position of an end-of-block coefficient in a quantized transform block, and quantized transformed coefficients of the quantized transform block coded using a wavefront scan order, wherein the wavefront scan order is characterized by coding respective quantized transform coefficients of flipped L-shaped regions, and first quantized transform coefficients along a first axis of a flipped L-shaped region are coded followed by coding second quantized transform coefficients along a second axis of the flipped L-shaped region.

18. (canceled)

19. (canceled)

20. (canceled)

21. The non-transitory computer-readable storage medium of claim 17, wherein the position of the end-of-block coefficient in the quantized transform block comprises a first syntax element indicating a wavefront that includes the end-of-block coefficient.

22. The non-transitory computer-readable storage medium of claim 21, wherein the position of the end-of-block coefficient in the quantized transform block comprises a second syntax element indicating whether the end-of-block coefficient is in a column or a row of the wavefront.

23. (canceled)

24. The non-transitory computer-readable storage medium of claim 21, wherein the position of the end-of-block coefficient in the quantized transform block comprises a second syntax element indicating an offset of the end-of-block coefficient to a predetermined location in the wavefront.
